(19) United States
(12) Patent Application Publication
(10) Pub. No.: US 2008/0240768 A1
(43) Pub. Date: Oct. 2, 2008

(54) Image Forming Apparatus and Image Forming Method

(75) Inventors: Yuichi SEGAWA, Shiojiri-shi (JP); Minoru KISHIGAMI, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/043,836

(22) Filed: Mar. 6, 2008

(30) Foreign Application Priority Data
Mar. 26, 2007 (JP) 2007-078339
Mar. 26, 2007 (JP) 2007-078340

(51) Int. Cl. G03G 21/20

(52) U.S. Cl. 399/92

(57) ABSTRACT

An image forming apparatus, includes: an image forming section that forms a toner image and transfers the toner image to a recording material at a predetermined transfer position; a fixing unit that heats the toner image on the recording material at a predetermined fixing position and fixes the toner image to the recording material; a transporter that transports the recording material along a transportation path including a path extending from the transfer position to the fixing position; a heat absorber that is located on the transportation path at a place downstream of the fixing position and absorbs a heat from the recording material; a pre-heater that is located on the transportation path at a pre-heating position upstream of the transfer position and pre-heats the recording material passing through the pre-heating position; and a heat transfer unit that transfers a heat energy obtained by the heat absorber absorbing the heat to the pre-heater.

### CROSS REFERENCE TO RELATED APPLICATION

The disclosure of Japanese Patent Applications No. 2007-078339 and No. 2007-078340 filed on Mar. 26, 2007 including specification, drawings and claims is incorporated herein by reference in its entirety.

### BACKGROUND

1. Technical Field

The invention relates to an image forming apparatus and method in which a toner image transferred to a recording material is permanently fixed onto the recording material by heating the toner image.

2. Related Art

In the image forming apparatuses, such as copiers, printers and facsimile machines, which use a toner to form an image on the recording material, the toner image is permanently fixed onto the recording material by heating the recording material having the toner image transferred thereto. Such image forming apparatuses encounter problems associated with waste heat resulting from a fixing operation. For instance, some members constituting the apparatus may be damaged by the heat resulting from the fixing operation. Further, water vapor released from the warmed recording material may be accumulated in the apparatus so that water droplet may adhere to the recording material to cause image defects or that dew condensation occurs in the apparatus to interfere with smooth transportation of the recording material.

An image forming apparatus set forth in Japanese Patent No. 2555278, for example, approaches such problems as follows. The apparatus is provided with an exhaust-air flow path and an exhaust fan such that fresh air may be taken in through a paper exit to flow adversely through a paper discharge path. This structure prevents the components of the paper discharge path from being heated and provides for the use of low-cost parts.

The above related art technique is adapted to prevent the components of the paper discharge path from being heated. However, the problems associated with the water vapor released from the recording material described above cannot be solved. The related art technique is simply designed to discharge the waste heat to the outside of the apparatus, failing to achieve the increase of energy efficiency with respect to power consumption.

### SUMMARY

An advantage of some aspects of the invention is to solve the problems associated with the water vapor released from the recording material in the fixing operation and to enhance the energy efficiency of the apparatus in the image forming apparatus and method in which the toner image transferred to the recording material is permanently fixed onto the recording material by heating the toner image.

According to a first aspect of the invention, a recording material is transported along a predetermined transportation path, and a toner image is transferred to the recording material at a transfer position on the transportation path. And the toner image is heated by a fixing unit to be fixed onto the recording material at a fixing position on the transportation path and downstream of the transfer position. Then, waste heat from the fixing unit is transferred to a pre-heating position on the transportation path and upstream of the transfer position. The recording material passing through the pre-heating position is pre-heated with the heat thus transferred.

According to a second aspect of the invention, a recording material is transported along a predetermined transportation path, and a toner image is transferred to the recording material at a transfer position on the transportation path. And the toner image is heated to be fixed onto the recording material at a fixing position on the transportation path and downstream of the transfer position. The heat of the recording material is absorbed at a place on the transportation path and downstream of the fixing position. The recording material passing through a pre-heating position on the transportation path and upstream of the transfer position is pre-heated with a heat energy obtained by the heat absorption.

According to these constitutions, the release of water vapor from the recording material at the fixing position is suppressed because some of the moisture in the recording material is previously released as water vapor by pre-heating the recording material. Hence, the problems such as the dew condensation occurring around the fixing position and the jamming of recording material may be obviated. In addition, the increase of energy efficiency may be achieved because the waste heat resulting from the fixing operation is used for pre-heating and because the amount of heat required for image fixing is reduced by pre-heating the recording material.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a side view showing an internal construction of a first embodiment of an image forming apparatus according to the invention.

FIG. 2 is a block diagram showing an electrical configuration of the image forming apparatus of FIG. 1.

FIG. 3 is a diagram showing a sheet transportation path of this image forming apparatus.

FIG. 4 is a diagram showing the internal construction of the image forming apparatus of this embodiment.

FIG. 5 is a side view showing an internal construction of a second embodiment of an image forming apparatus according to the invention.

FIG. 6 is a diagram showing the internal construction of the image forming apparatus of this embodiment.

FIG. 7 is a side view showing an internal construction of a third embodiment of an image forming apparatus according to the invention.

FIG. 8 is a side view showing an internal construction of the fourth embodiment of the image forming apparatus according to the invention.

FIG. 9 is a diagram showing a sheet transportation path in this embodiment.

FIG. 10 is a view showing the internal construction of the image forming apparatus of this embodiment.

### DESCRIPTION OF EXEMPLARY EMBODIMENTS

### First Embodiment

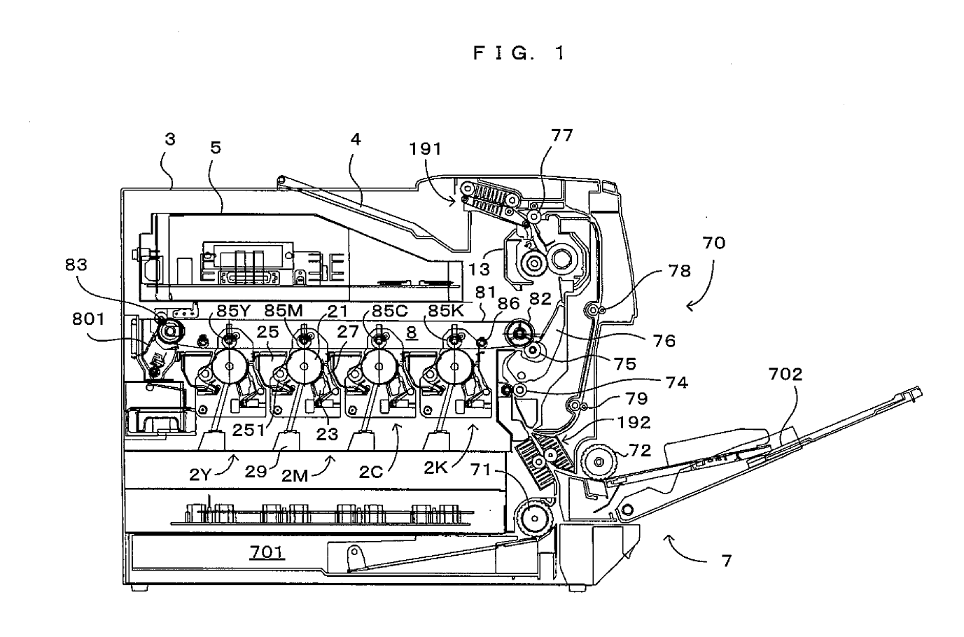

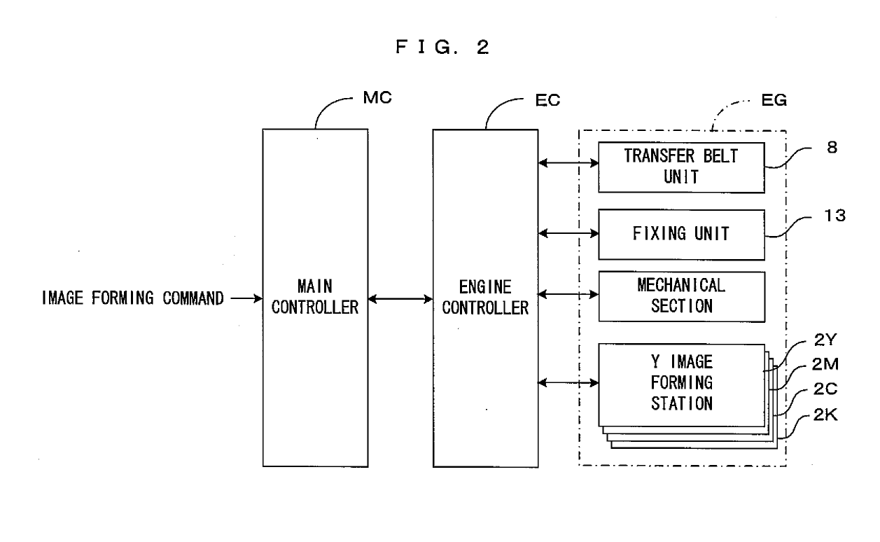

FIG. 1 is a side view showing an internal construction of a first embodiment of an image forming apparatus according to the invention. FIG. 2 is a block diagram showing an electrical configuration of the image forming apparatus of FIG. 1. This apparatus is an image forming apparatus which is able to execute selectively a color mode to form a color image by superimposing toner images of four colors including yellow (Y), magenta (M), cyan (C) and black (K) and a monochromatic mode to form a monochromatic image by using only a black (K) toner. The image forming apparatus operates as follows. When an external apparatus such as a host computer applies an image forming command to a main controller MC including CPU, memory and the like, the main controller MC applies a control signal to an engine controller EC. Based on the control signal, the engine controller EC executes a predetermined image forming operation by controlling individual parts of the apparatus such as an engine EG, whereby an image corresponding to the image forming command is formed on a sheet as a recording material such as copy paper, transfer paper, paper and transparent sheet for OHP.

An electrical component box 5 incorporating a power supply circuit board, the main controller MC, the engine controller EG is disposed in a housing body 3 of the image forming apparatus. Image forming stations 2Y, 2M, 2C, 2K, a transfer belt unit 8 and a sheet feeding unit 7 are also disposed in the housing body 3. The housing body 3 is provided with a fixing unit 13 and a sheet transporting unit 70 on the right side in FIG. 1.

The image forming apparatus includes four image forming stations 2Y (for yellow), 2M (for magenta), 2C (for cyan) and 2K (for black) which form toner images of mutually different colors.

Meanwhile, since the respective image forming stations are identically constructed, reference characters are given to only some of the image forming stations while being not given to the other image forming stations in order to facilitate the diagrammatic representation in FIG. 1.

Each of the image forming stations 2Y, 2M, 2C, 2K is provided with a photosensitive drum 21 on the surface of which a toner image of each color is to be formed. Each of the photosensitive drums 21 is connected to its own driving motor and is driven to rotate in a predetermined direction at a predetermined speed. Around the photosensitive drum 21, a charger 23, an exposure unit 29, a developer 25 and a photosensitive drum cleaner 27 are arranged in the rotational direction of the photosensitive drum 21. A charging operation, a latent image forming operation and a toner development operation are performed by these functional sections. In the execution of the color mode, the toner images formed by all the image forming stations 2Y, 2M, 2C, 2K are superimposed on a transfer belt 81 of the transfer belt unit 8 so as to form the color image. In the execution of the monochromatic mode, only the image forming station 2K is operated to form a black monochromatic image.

The charger 23 includes a charging roller having the surface thereof made of an elastic rubber. This charging roller is in contact with the surface of the photosensitive drum 21 at a charging position, and rotates driven with the rotation of the photosensitive drum 21. This charging roller is connected to a charging bias generator not shown and charges the surface of the photosensitive drum 21 at a predetermined surface potential.

The exposure unit 29 irradiates light on the surface of the photosensitive drum 21 so charged by the charger 23 thereby forming an electrostatic latent image on the surface.

The developer 25 includes a developing roller 251 carrying a toner on the surface thereof. A developing bias generator (not shown) electrically connected to the developing roller 251 applies a developing bias to the developing roller 251. At a development position where the developing roller 251 and the photosensitive drum 21 abut against each other, the developing bias causes the charged toner to transfer from the developing roller 251 to the photosensitive drum 21 so that the electrostatic latent image formed on the surface of the photosensitive drum is visualized.

The toner image visualized at the development position is transported in the rotational direction of the photosensitive drum 21. Then, the toner image is primarily transferred to the transfer belt 81 at a primary transfer position where the transfer belt 81 makes contact with each of the photosensitive drums 21. The details of the primary transfer position will be described hereinafter.

The photosensitive drum cleaner 27 abutting against the surface of the photosensitive drum 21 is disposed at a place downstream from the primary transfer position and upstream of the charger 23 with respect to the rotational direction of the photosensitive drum 21. This photosensitive drum cleaner 27 abuts against the surface of the photosensitive drum 21 thereby cleaning the surface of the photosensitive drum 21 of the toner remaining thereon after the primary transfer.

The transfer belt unit 8 includes a driving roller 82, a driven roller (blade facing roller) 83 arranged to the left of the driving roller 82 in FIG. 1, and the transfer belt 81 mounted on these rollers and driven to turn in a predetermined direction by the rotation of the driving roller 82. The transfer belt unit 8 also includes four primary transfer rollers 85Y, 85M, 85C and 85K arranged to face in a one-to-one relationship with the photosensitive drums 21 of the respective image forming stations 2Y, 2M, 2C and 2K inside the transfer belt 81 when the photosensitive cartridges are mounted. These primary transfer rollers 85Y, 85M, 85C and 85K are respectively electrically connected to a primary transfer bias generator not shown.

In the image forming apparatus of a so-called tandem system, the primary transfer position where the toner image is primarily transferred from the photosensitive drum 21 to the transfer belt 81 varies from one image forming station to another. Specifically, the yellow image forming station 2Y, the magenta image forming station 2M, the cyan image forming station 2C and the black image forming station 2K are arranged in this order in the moving direction of the transfer belt 81.

The transfer belt unit 8 further includes a downstream guide roller 86 disposed at a place downstream of the black primary transfer roller 85K and upstream of the driving roller 82. The downstream guide roller 86 is arranged to abut against the transfer belt 81 on a common tangent of the primary transfer roller 85K and the black photosensitive drum 21(K) at the primary transfer position defined by the primary transfer roller 85K abutting against the photosensitive drum 21 of the image forming station 2K.

The sheet feeding unit 7 includes a sheet cassette 701 capable of retaining stacked sheet-like recording material (hereinafter simply referred to “sheet”), and a manual feed tray 702 permitting the sheets to be placed thereon. The sheets set on the sheet cassette 701 or the manual feed tray 702 are taken out one by one by way of the rotation of a pickup roller 71 or 72 provided at the sheet transporting unit 70 and fed into a transportation path to be described hereinafter. Whether the sheet is fed from the sheet cassette 701 or the manual feed tray 702 is specified by a user setting. The sheet fed by the pickup roller 71 or 72 is adjusted for feeding timing by means of a gate roller pair 74 provided at the sheet transporting unit 70. Thereafter, the sheet is transported along a sheet guide member 76 to a secondary transfer position where the driving roller 82 and a secondary transfer roller 75 abut against each other.

The secondary transfer roller 75 as a component of the sheet transporting unit 70 is free to move into or out of contact with the transfer belt 81 and is driven into or out of contact by means of a secondary transfer roller driving mechanism (not shown). The sheet having the image secondarily transferred thereon is guided to the fixing unit 13 by means of the sheet guide member 76. The fixing unit 13, in turn, permanently fixes the toner image onto the sheet by heating and pressing the toner transferred to the sheet. The sheet gone through the fixing process by the fixing unit 13 is transported to a discharge tray 4 disposed at an upper side of the housing body 3.

When images are to be formed on the both surfaces of a sheet, the sheet seating an image on its one surface in the manner above is fed into a reverse transportation path described hereinafter at a timing when the rear end of the sheet is transported to a switch back position which is downstream of the pre-discharge roller 77. The sheet is returned back to the former transportation path again before arriving at the gate roller pair 74 by means of feed roller pairs 78 and 79 which are disposed along the reverse transportation path and constitute the sheet transporting unit 70. At this time, the surface of the sheet which abuts on the transfer belt 81 in the secondary transfer position and is to receive a transferred image is the opposite surface to the surface on which the image is already transferred. In this fashion, it is possible to form images on the both surfaces of the sheet.

In this apparatus, a cleaner 801 is disposed opposing to the blade facing roller 83. The cleaner 801 presses its tip against the blade facing roller 83 via the transfer belt 81, thereby removing foreign substances including the toner remaining on the transfer belt 81 after secondary transfer, paper dust and the like. The foreign substances thus removed are collected in a waste toner box.

In the image forming apparatus, each of the image forming stations 2Y, 2M, 2C, 2K is unitized as a cartridge including the photosensitive drum 21, the charger 23, the developer 25 and the photosensitive drum cleaner 27. The cartridge is designed to be removably mountable in an apparatus body. Each of the cartridges is equipped with a non-volatile memory for storing information on the cartridge. Data communications are carried out between the engine controller EC and each of the cartridges. This permits the information on the respective cartridges to be transferred to the engine controller EC and the information stored in the respective memories to be updated. The operation histories and the lives of consumable articles of the respective cartridges are managed based on these pieces of information.

In FIG. 2, motors, clutches and the like for driving movable parts such as the rollers and the belts into rotation or into contact and out of contact, namely constitutions for generating mechanical driving forces are collectively referred to as a “mechanical section”.

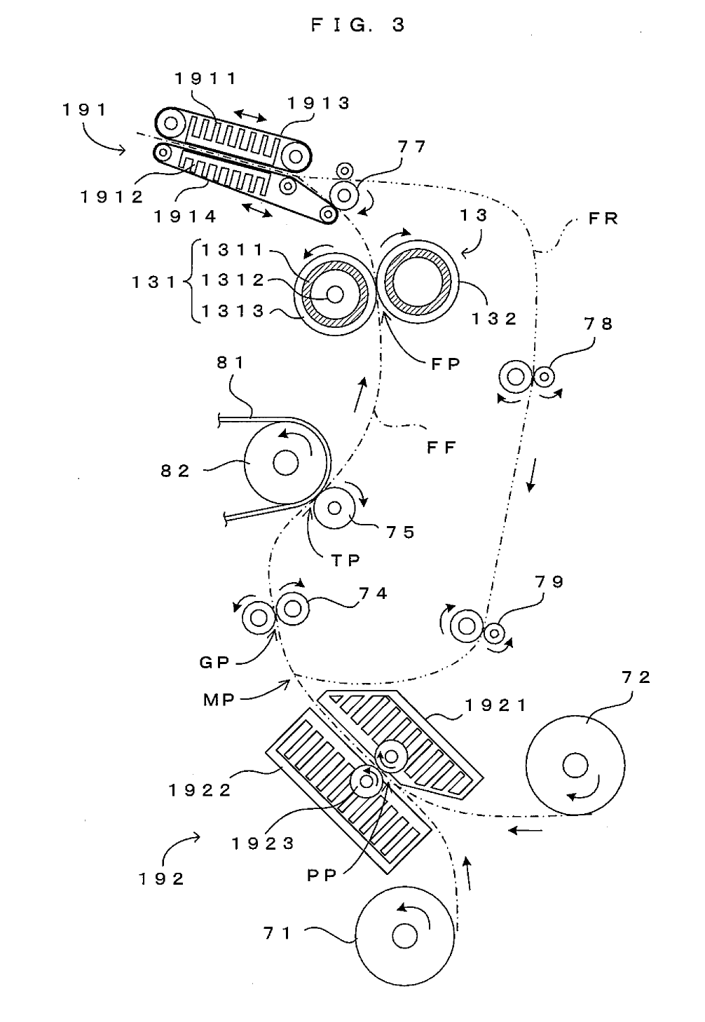

FIG. 3 is a diagram showing a sheet transportation path of this image forming apparatus. For the purpose of clearly depicting the sheet transportation path, the sheet guide members disposed along the sheet transportation path for guiding the sheet in the moving direction are omitted in FIG. 3. Arrows without reference characters, which are put in the vicinity of the individual members, indicate the respective moving directions of the members. Those arrows put along the transportation paths FF and FR indicate the respective sheet transporting directions of the transportation paths.

A sheet taken out from the sheet cassette 701 or the manual feed tray 702 by selectively rotating the pickup roller 71 or 72 is fed into the sheet transportation path FF via a pre-heating unit 192 to be described hereinafter. After a leading end of the sheet is brought to a feeding position GP on the transportation path FF, where the gate roller pair 74 is provided, the sheet comes to a temporary stop against a nip between the gate roller pair 74. When the gate roller pair 74 starts to rotate in synchronization with the progress of the image forming operation, the sheet is transported from the feeding position GP to a transfer position TP where the toner image on the transfer belt 81 is transferred to the sheet. The transfer position TP is used as synonymous with the aforementioned secondary transfer position.

The sheet having the image thus transferred thereon is fed into a fixing nip defined by a heating roller 131 and a pressing roller 132 provided at the fixing unit 13. The fixing unit 13 includes the heating roller 131 and the pressing roller 132 for pressingly biasing the heating roller 131. The heating roller 131 has a heating element such as a halogen heater built-in, is adjusted for a predetermined fixing temperature (about 200 degrees centigrade for instance) by way of temperature control, and is free to rotate. More specifically, the heating roller 131 is a roller in which a surface layer 1313 made of an elastic, heat-resistant resin such as silicone rubber on a surface of a metal pipe 1311 containing therein a heater 1312. The heater 1312 is, for example, a halogen heater having a heat release value of about hundreds to a thousand watts. The surface layer 1313 is composed of the resin having elasticity and heat resistance and may have an arrangement, for example, in which the silicone rubber layer is coated with a fluorine resin such as PFA (tetrafluoroethylene-perfluoroalkyl vinyl ether copolymer).

The pressing roller 132 has the same construction as that of the above heating roller 131 except that the heater is omitted. A constitution is made such that the pressing roller 132 is pressed against a circumferential surface of the heating roller 131 thereby defining a wide fixing nip defined between the heating roller 131 and the pressing roller 132. The sheet having the toner image transferred thereto and advanced from the transfer position TP is transported along the transportation path FF and discharged via a fixing position FP formed with the fixing nip. In this process, a heat and a pressure are applied to the toner at the fixing position FP so that the toner image is fixed onto the sheet.

A heat absorbing unit 191 is disposed on the transportation path FF at a place downstream of the fixing position FP. The heat absorbing unit 191 includes fins 1911 and 1912 made of a metal having high thermal conductivity such as copper or aluminum, and heat absorbing belts 1913 and 1914 entrained about plural rollers so as to surround the respective fins and endlessly moving around the respective fins in the sheet transporting direction. The heat absorbing belts 1913, 1914 are endless belts made of a material having high thermal conductivity such as a resin having carbon fiber or fine metal particles dispersed therein. These two belts abut against each other on the transportation path FF for defining a heat absorbing nip. When the heated sheet discharged from the fixing unit 13 passes through the heat absorbing nip, the heat is transferred from the sheet to the heat absorbing belts 1913 and 1914 so that the sheet is cooled down while the heat absorbing belts 1913 and 1914 are warmed up. The heat transferred to the heat absorbing belts 1913 and 1914 is further transferred to the fins 1911 and 1912 in contact with these belts, whereby the air in spaces enclosed by the heat absorbing belts 1913 and 1914 is warmed up.

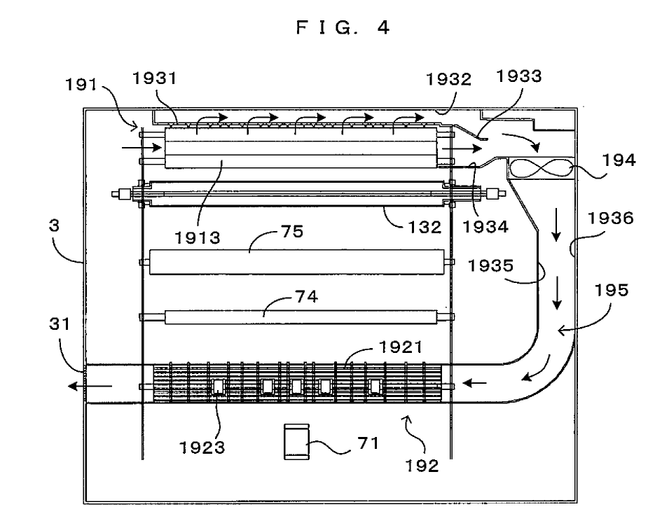

FIG. 4 is a diagram showing the internal construction of the image forming apparatus of this embodiment, as seen from the front side thereof (from the right side in FIG. 1). Duct forming members 1931, 1932 are disposed adjacent to and above the heat absorbing unit 191. Further, duct forming members 1935, 1936 are disposed at a lateral side of the apparatus. These duct forming members constitute a ventilation duct 195 interconnecting the vicinity of the heat absorbing unit 191 and the vicinity of the pre-heating unit 192. Air warmed by the heat released from the fixing unit 13 and the heat absorbing unit 191 flows into the ventilation duct 195. Disposed in the duct is an exhaust fan 194 for generating airflow. Hence, the air near the heat absorbing unit 191 is carried through the ventilation duct 195 by the airflow generated by the operating exhaust fan 194, to pass through the pre-heating unit 192 and to be finally discharged from the apparatus via an exhaust port 31 disposed on the left side in FIG. 4. Meanwhile, arrows without reference characters indicate a direction of the airflow in FIG. 4.

Duct forming members 1933, 1934 are further provided for guiding the air from the spaces enclosed by the respective heat absorbing belts 1913, 1914 into the duct. Hence, the air warmed as passing through the fins 1911, 1912 disposed inwardly of these belts 1913, 1914 also flows into the ventilation duct 195. Thus, the waste heat generated in the vicinity of the fixing unit 13 is fed into the pre-heating unit 192 by the airflow moving through the ventilation duct 195. When the sheet is not passed through the fixing unit 13, as well, the air warmed by the waste heat from the fixing unit 13 is fed into the pre-heating unit 192 via the ventilation duct 195.

The pre-heating unit 192, as shown in FIG. 3, includes metallic pre-heating members 1921, 1922 having a hollow construction allowing the warmed air so fed via the ventilation duct 195 to pass therethrough. These pre-heating members 1921, 1922 are made of a metal having high thermal conductivity such as aluminum or copper and are formed with fins on their inner sides for the increase of the surface areas thereof. The warmed air passes through the hollow pre-heating members 1921, 1922 in this manner so that the pre-heating members 1921, 1922 are also warmed up.

A feed roller pair 1923 is mounted to place near these pre-heating members 1921, 1922. The feed roller pair is warmed by the warmed pre-heating members 1921, 1922 and the air passing therethrough. A sheet fed anew into the transportation path FF by way of the rotation of the pickup roller 71 or 72 is pre-heated by the heat from the pre-heating members 1921, 1922 and the feed roller pair 1923 at a pre-heating position PP where the sheet comes into contact with these members.

The pre-heating position PP is located on the front side, or upstream of the feeding position GP provided with the gate rollers 74 with respect to the sheet transporting direction. The followings are the reasons for locating the pre-heating position in this manner. From the standpoint of pre-heating the sheet prior to image fixing, the pre-heating position PP may be located upstream of at least the fixing position FP. However, the toner image on the sheet is unfixed to the sheet transported between the transfer position TP and the fixing position FP and hence, it is practically impossible for the pre-heating members to make contact with the sheet transported between these members. This dictates the need for locating the pre-heating position PP upstream of the transfer position TP.

It is also required to bring the pre-heating members and feed roller pair into contact with the sheet with high contact pressure in order to permit the heat of the pre-heating members to be efficiently transferred to the sheet. It is noted here that the gate rollers 74 feed the sheet from the feeding position GP to the transfer position TP in a proper timing synchronized with the process of the image forming operation, thereby controlling the position of the toner image transferred onto the sheet. Therefore, if the pre-heating position PP is located between the feeding position GP and the transfer position TP, the gate rollers 74 feed the sheet to the pre-heating position PR. This involves a possibility that a sheet transporting speed at the pre-heating position PP constitutes a rate controlling factor which may detrimentally disrupt the timing of the sheet being delivered to the transfer position TP.

By the aforementioned reasons, it is preferred that the pre-heating position PP is located upstream of the feeding position GP with respect to the sheet transporting direction, the feeding position where the sheet feeding by the gate rollers 74 is started. According to this arrangement, the sheet is pulled by the gate rollers 74 so that the sheet is tensioned between the pre-heating position PP and the feeding position GP. Hence, the sheet may be brought into close contact with the pre-heating members 1921, 1923 so as to be more efficiently pre-heated. According to the embodiment, the sheet cassette 701 and the manual feed tray 702 are provided as the two types of sheet feeding sources. The recording materials fed from the respective sheet feeding sources are placed on the same transportation path FF. In the constitution in which the plural sheet feeding sources of the recording material are provided and transportation paths starting from the respective sheet feeding sources join together, the pre-heating position PP may preferably be located downstream of the junction of these paths.

Next, a reverse transportation path FR is discussed. The sheet fed into the reverse transportation path FR is transported by means of the transporting roller pairs 78, 79 and returned to the former transportation path FF via a merging position MP. The merging position MP is located on the transportation path FF at a place downstream of the pre-heating position PP and upstream of the transfer position TP with respect to the sheet transporting direction. The followings are the reasons for locating the merging position MP in this manner. The sheet transported on the reverse transportation path FR has just passed through the fixing position FP and is already warmed up. Hence, the sheet need not be pre-heated again. Further, the sheet which has been transported via the transportation paths FF and FR may sometimes get curled or a warpage. Such a sheet is likely to get stuck on some of the members constituting the transportation paths to cause transportation failure. The likelihood of causing the transportation failure may be reduced by allowing the sheet to bypass the pre-heating position PP through which the sheet need not necessarily be passed.

Next, description is made on the effect of pre-heating. According to the result of the experiments performed by the inventors of the present application, when the room temperature is at 20 degrees centigrade, the temperature of the sheet is also at 20 degrees centigrade if it is not subjected to the pre-heating by the pre-heating unit 192, and the temperature of the heating roller 131 required for achieving a good fixing characteristic is about 190 degrees centigrade or more. On the other hand, it is found that if the sheet is pre-heated by the pre-heating unit 192, the heating roller 131 need be raised in temperature only to 180 degrees centigrade for achieving the good fixing characteristic. In this case, the temperature of the pre-heating members 1921, 1922 are about 35 degrees centigrade, while the temperature of the pre-heated sheet is at about 30 degrees centigrade.

Thus, pre-heating the sheet permits the heating roller 131 provided at the fixing unit 13 to be set to the lower temperature, so that the power consumption of the heater 1312 for raising the temperature of the heating roller 131 may be reduced. Accordingly, the power consumption of the apparatus may be reduced. Since the pre-heating operation utilizes the waste heat resulting from the fixing operation, the increased power consumption is not entailed by carrying out the pre-heating operation. Hence, the apparatus can achieve the increased energy efficiency. Further, the moisture content of the sheet delivered to the transfer position TP may be lowered from the initial level by pre-heating the sheet, so that the dew condensation inside the apparatus and the sheet transportation failure are prevented.

From the standpoint of reducing the water vapor, it is not preferred to expose the sheet at the pre-heating position PP to the air warmed by making contact with the fixing unit or the sheet right after the fixing operation. The reason is that such an air retains a lot of water vapor released from the sheet at the fixing position FP and is rather likely to impart moisture to the sheet. On the other hand, in this embodiment, it is constituted to warm up the pre-heating members by using the air warmed by heat absorption and to prevent the air around the fixing unit 13 from making contact with the sheet, and hence, such a problem does not occur.

### Second Embodiment

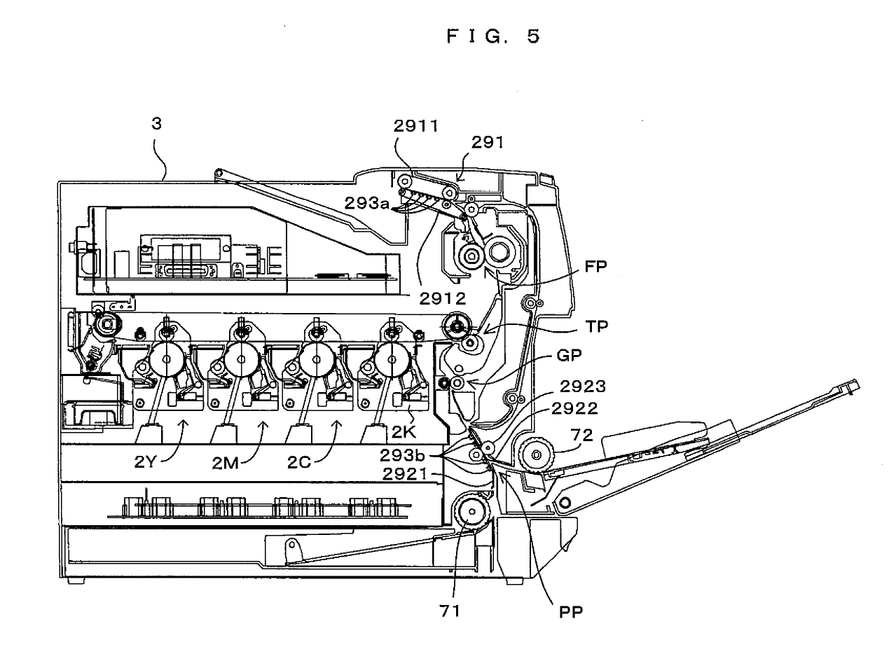

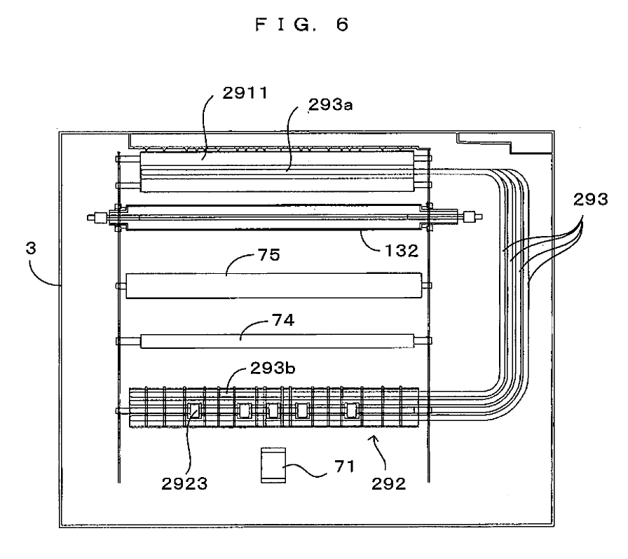

FIG. 5 is a side view showing an internal construction of a second embodiment of an image forming apparatus according to the invention. FIG. 6 is a diagram showing the internal construction of the image forming apparatus of this embodiment, as seen from the front side thereof (from the right side in FIG. 5). The apparatus of the second embodiment differs from the apparatus of the first embodiment in the constructions of the heat absorbing unit and the pre-heating unit, and in that the ventilation duct is replaced by a heat pipe. Except for this, the apparatus is constructed the same way as the apparatus of the first embodiment. Accordingly, like reference characters refer to the corresponding components of the apparatus of the first embodiment and the specific description thereof is dispensed with.

A heat absorbing unit 291 of the image forming apparatus of the second embodiment includes heat absorbing belts 2911, 2912 entrained about plural rollers and endlessly moving around the rollers in the sheet transporting direction. Similarly to the heat absorbing belts of the first embodiment, the heat absorbing belts 2911, 2912 are endless belts made of a material having high thermal conductivity such as a resin having carbon fiber or fine metal particles dispersed therein. Respective one ends 293a of four heat pipes 293 abut against the heat absorbing belt 2912. The heat pipe 293 has a heat transport medium sealed therein, acting to absorb heat at one end thereof and to release the heat from the other end thereof.

As shown in FIG. 6, the heat pipe 293 extends downward to be connected to a pre-heating unit 292 at the other end thereof. The pre-heating unit 292 includes a guide member 2921 disposed along the sheet transportation path, a pressing member 2922 made of an elastic thin sheet for biasing the sheet passing through the sheet transportation path in a manner to press the sheet against the guide member 2921, and a feed roller pair for transporting the sheet along the guide member 2921. The guide member 2921 is made of a material having high thermal conductivity, such as aluminum or copper. The pressing member 2922 is made of a material, such as a PET resin film, having elasticity and low surface friction coefficient. The other end 293b of each heat pipe 293 is fixed to a main surface of the guide member 2921 on the side opposite to its main surface facing the transportation path.

In this embodiment constituted in such a manner, the sheet heated while passing through the fixing position FP is brought into contact with the heat absorbing unit 291, whereby the sheet is removed of the heat and cooled down. The heat drawn by the heat absorbing unit 291 is transferred to the one end 293a of each heat pipe 293 and released from the other end 293b thereof for warming up the pre-heating unit 292. Thus, the pre-heating unit 292 pre-heats the sheet passing through the pre-heating position PP.

In this embodiment, the heat absorbed from the sheet by means of the heat absorbing unit 291 is transported to the pre-heating unit 292 by means of the heat pipes 293. Similarly to the first embodiment, therefore, it is possible to prevent the dew condensation and the sheet transportation failure caused by the moisture evaporated from the sheet in the second embodiment. Further, it is possible to reduce the power consumption because the amount of heat necessary to provide to the sheet in the fixing unit is reduced by pre-heating the sheet. What is more, the energy efficiency is increased because the waste heat is used for pre-heating. The embodiment is superior to the first embodiment in terms of the heat transport efficiency although the apparatus cost is higher than that of the first embodiment. According to the experiments performed by the inventors of the present application, when the room temperature is at 20 degrees centigrade, the temperature of the guide member 2921 is raised to about 50 degrees centigrade so that the guide member is able to raise the sheet temperature to about 42 degrees centigrade. It is also found that the temperature of the heating roller need be raised to not more than about 170 degrees centigrade. In addition, a heat transporting speed is so high that a time lag between the passage of the sheet through the fixing position FP and the rise of temperature at the pre-heating position PP is small.

### Third Embodiment

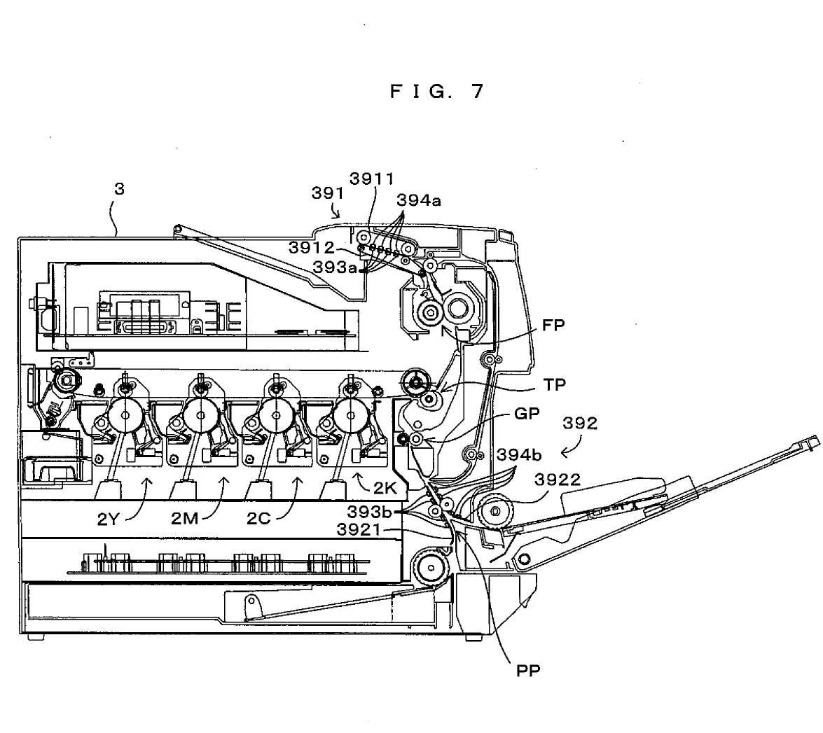

FIG. 7 is a side view showing an internal construction of a third embodiment of an image forming apparatus according to the invention. In this embodiment, similarly to the second embodiment, a heat absorbing belt 3912 is disposed in a heat absorbing unit 391, and heat pipes are disposed such that one ends 393a thereof abut against the heat absorbing belt 3912. The respective other ends 393b of the heat pipes are fixed to a guide member 3921 disposed in a pre-heating unit 392. In this embodiment, however, heat pipes are further disposed such that respective one ends 394a thereof abut against the other heat absorbing belt 3912 disposed in the heat absorbing unit 391. The respective other ends of the heat pipes are fixed to another guide member 3922 disposed in the heat absorbing unit 392. The guide member 3922 opposes the guide member 3921 via the sheet transportation path so that the sheet is transported through space defined between these guide members. Except for this, this embodiment is constituted the same way as the second embodiment.

In this embodiment, as described above, the heat absorbing unit 391 is structured to absorb heat from the both sides of the sheet while the pre-heating unit 392 is structured to pre-heat the sheet on the both sides thereof. This permits the heat to be more efficiently drawn from the sheet gone through the fixing operation, and the heat thus obtained to be more efficiently transferred to the sheet for pre-heating the sheet.

### Summary of First to Third Embodiments

As described above, in all the aforementioned embodiments, the recording sheet having passed through the fixing position FP and being at high temperature is brought into contact with the heat absorbing member, whereby the heat is absorbed from the sheet, and the absorbed heat is used for warming up the pre-heating member disposed at the pre-heating position PP upstream of the transfer position TP. The sheet is pre-heated in these embodiments by bringing the sheet into contact with the pre-heating member thus warmed. In this way, the moisture in the sheet is previously reduced so that the image defects caused by the water droplet on the sheet, the dew condensation occurring in the vicinity of the fixing position FP and the sheet transportation failure may be obviated. Since the waste heat resulting from the fixing operation is used for pre-heating, it is unnecessary for consuming additional power for the pre-heating operation. In addition, the temperature of the fixing unit may be set to the lower level by virtue of pre-heating the sheet. Hence, the apparatus as a whole may achieve the reduction of power consumption and the increased energy efficiency.

As described above, in each of the aforementioned embodiments, the image forming stations 2Y, 2M, 2C, 2K and the transfer belt unit 8, as a unit, function as the “image forming section” of the invention. The fixing unit 13 functions as the “fixing unit” of the invention. The heating roller 131 and the heater 1312 correspond to the “heating member” and the “heat generating member” of the invention, respectively. In these embodiments, the sheet transporting unit 70 functions as the “transporter” of the invention, and the gate roller pair 74 corresponds to the “feeding member” of the invention.

The heat absorbing unit 191 in the first embodiment, the heat absorbing unit 291 in the second embodiment and the heat absorbing unit 391 in the third embodiment function as the “heat absorber” of the invention, respectively. Further, the preheating unit 192 in the first embodiment, the pre-heating unit 292 in the second embodiment and the pre-heating unit 392 in the third embodiment function as the “pre-heater” of the invention, respectively.

The duct forming members 1931 to 1936 in the first embodiment function as the “ventilation path forming member” of the invention, while the exhaust fan 194 functions as the “airflow generator” of the invention, and these members, as a unit, constitute the “heat transfer unit” of the invention. The fins 1911 and 1912 disposed in the heat absorbing unit 191 in the first embodiment function as the “air warming member” of the invention. The pre-heating members 1921 and 1922 disposed in the pre-heating unit 192 function as the “pre-heating member” of the invention.

In the second and third embodiments, the heat pipes 293 and the like function as the “heat transfer unit” of the invention, respectively. The heat absorbing belts 2911, 2912, 3911 and 3912 function as the “heat absorbing member” of the invention, respectively. The guide members 2921, 3921 and 3922 in the second and third embodiments function as the “pre-heating member” of the invention, respectively.

### Fourth Embodiment

Next, a fourth embodiment of the invention is described. In the apparatuses in the first to third embodiments describe above, the heat energy is absorbed from the sheet which has passed through the fixing unit and is used for pre-heating another sheet. On the other hand, in an apparatus in the fourth embodiment, the pre-heat of the sheet is performed by means of the waste heat released from the fixing unit 13.

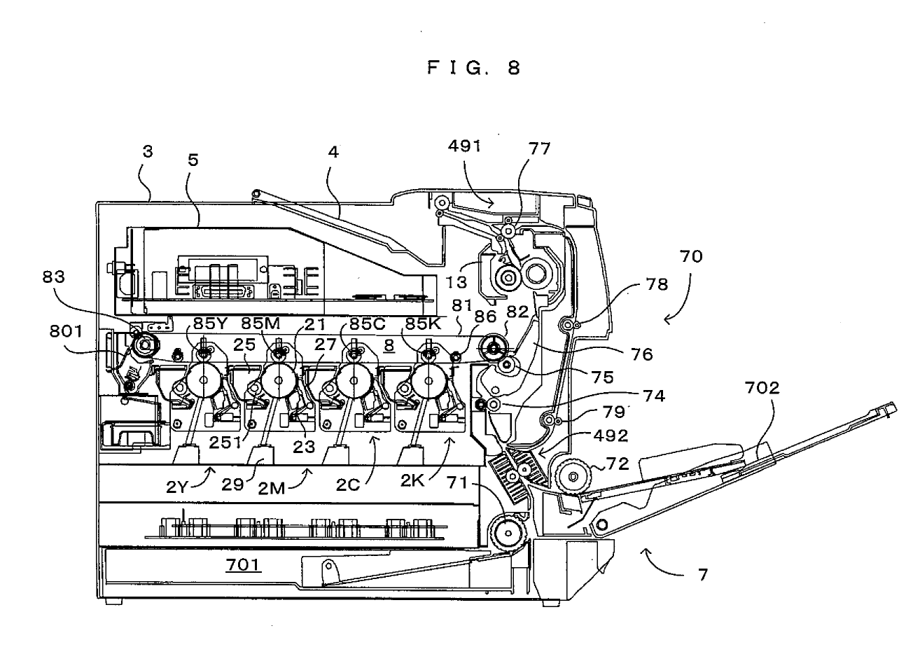

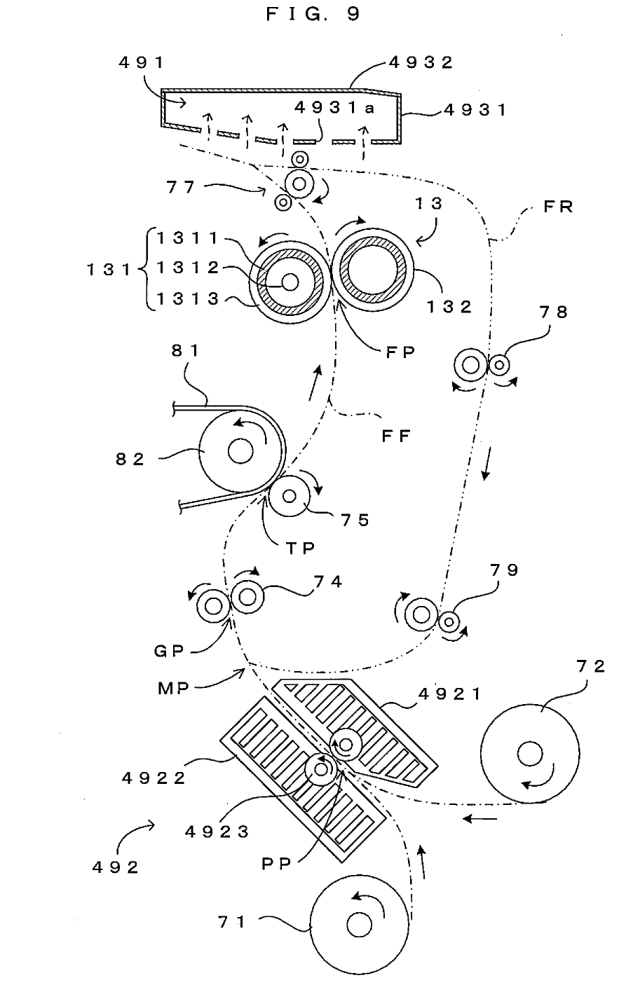

FIG. 8 is a side view showing an internal construction of the fourth embodiment of the image forming apparatus according to the invention. FIG. 9 is a diagram showing a sheet transportation path in this embodiment. Hereinafter, like reference characters refer to the corresponding components in the first embodiment and the detailed description thereof is dispensed with.

Disposed above the fixing unit 13 is an upper duct 491 which extends in a direction perpendicular to the planes of FIGS. 8 and 9. The upper duct is formed by being enclosed by an upper duct forming member 4931 and another upper duct forming member 4932. The upper duct forming member 4931 includes a plurality of ventilating holes 1931a. The other upper duct forming member 4932 constitutes a part of the upper side of the housing body 3 and covers an upper opening of the upper duct forming member 4931. Air in an upper part of the fixing unit 13 is warmed up by the waste heat released from the fixing unit 13 and the sheet having gone through the fixing operation and is moved into the upper duct 491 by convection and by drawing of an exhaust fan to be described hereinafter. In FIG. 9, arrows in broken lines indicate the direction of the airflow in the upper part of the fixing unit 13.

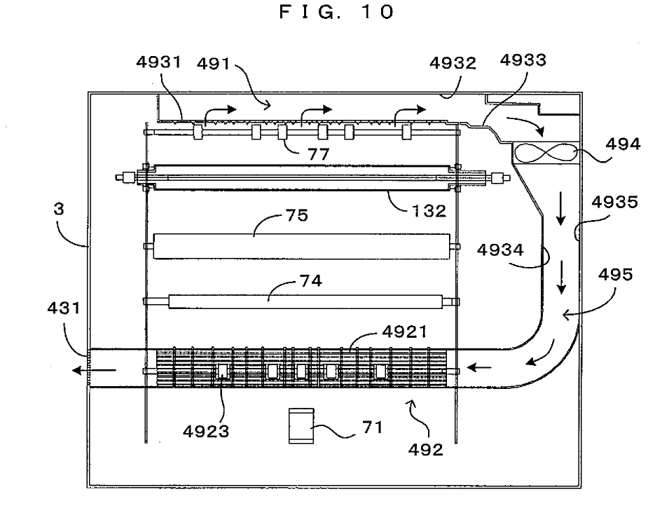

FIG. 10 is a view showing the internal construction of the image forming apparatus of this embodiment, as seen from the front side thereof (from the right-hand side in FIG. 8). The upper duct 491 constituted by the upper duct forming members 4931 and 4932 is communicated with a ventilation duct 495 enclosed by other duct forming members 4933, 4934 and 4935. Disposed in the duct is an exhaust fan 494, which is rotated to generate airflow flowing from the upper duct 491 and through the ventilation duct 495, as indicated by arrows in FIG. 10. The airflow thus generated flows through a hollow pre-heating member 4921 and the like disposed in a pre-heating unit 492 and is finally discharged from the apparatus body via an exhaust port 431 provided at a lateral side of the housing body 3.

In the fourth embodiment having the constitution described above, the air around the fixing unit 13, warmed up by the fixing unit 13 and the sheet having gone through the fixing operation, is drawn into the upper duct 491 to flow through the duct 495 so that the heat of the air is used for warming up the pre-heating members 4921 and 4922, just as in the aforementioned apparatus in the first embodiment. The warmed pre-heating members 4921 and 4922, in turn, pre-heat the sheet passing through the pre-heating position PP.

As described above, in the fourth embodiment, the air warmed up by the fixing unit 13 and the sheet having gone through the fixing operation is moved through the pre-heating members 4921, 4922 disposed at the pre-heating position PP upstream of the transfer position TP, thereby warming up the pre-heating members. The sheet is pre-heated by bringing the sheet into contact with the pre-heating members thus warmed up in this embodiment. The moisture in the sheet is thus previously reduced by pre-heating the sheet so that the image defects caused by the adhering water droplet on the sheet, the dew condensation occurring in the vicinity of the fixing position FP and the sheet transportation failure may be obviated. Further, since the waste heat resulting from the fixing operation is used for pre-heating, it is unnecessary for consuming additional power for the pre-heating operation. In addition, the temperature of the fixing unit may be set to the lower level by virtue of pre-heating the sheet. Hence, the apparatus as a whole may achieve the reduction of power consumption and the increased energy efficiency.

In the fourth embodiment, as described above, the pre-heating unit 492 functions as the “pre-heater” of the invention, and the pre-heating members 4921, 4922 function as the “pre-heating member” of the invention. Further, in the above embodiment, the upper duct forming members 4931, 4932, the duct forming members 4933 to 4935 and the exhaust fan 494, as a unit, function as the “heat transfer unit” of the invention or particularly as the “air feeder” of the invention.

It should be noted that the invention is not limited to the embodiment above, but may be modified in various manners in addition to the embodiment above, to the extent not deviating from the object of the invention. For instance, the fixing units of the above embodiments are constituted to form the fixing nip by abutting the heating roller 131 on the pressing roller 132 both having a roller shape. Alternatively, the fixing nip may be formed by abutting a pressing belt entrained about plural rollers on the heating roller.

Although the heat absorbing units in the above embodiments are constituted to absorb heat by bringing the sheet having passed through the fixing position FP into contact with the heat absorbing belts 1911 and the like, the constitution is not limited to this. A constitution that the heat of the sheet is absorbed by bringing the sheet into contact with a roller-shaped heat absorbing member may be adopted, for example. Further, the heat absorbing units and the pre-heating units are not limited to those of the above embodiments which include the members making contact with the sheet. For instance, the heat absorbing unit may be constituted to transfer the heat from the sheet to the air by blowing air over the sheet. The pre-heating unit may be constituted to pre-heat the sheet by blowing warmed air over the sheet. It is noted, however, that the air warmed up by making contact with the fixing unit and the sheet having gone through the fixing operation is likely to include a large amount of water vapor. From the standpoint of reducing the water vapor, it is not preferred to expose the sheet at the pre-heating position PP to such air. It is therefore preferred to adopt the constitution in which the pre-heating member is warmed up using the air warmed by heat absorption or the constitution in which only the heat so absorbed is transferred to the pre-heating position PP for warming up the air around the position.

Further, in the above fourth embodiment, the constitution in which the waste heat from the fixing unit 13 is used for pre-heating by feeding the warmed air in the upper part of the fixing unit 13 into the pre-heating unit 492, but the constitution is not limited to this. For instance, a similar constitution to that of the second embodiment may be adopted in which the heat absorbing member made of a material having high thermal conductivity such as a metal plate is disposed in the vicinity of the fixing unit 13, and one ends of the heat pipes abut against this heat absorbing member and the other ends thereof abut against the pre-heating member, thereby transferring the heat around the fixing member 13 to the pre-heating position PP.

Furthermore, in the above embodiments, although the invention is applied to the tandem-type full-color image forming apparatus using the toners of four colors YMCK, the application of the invention is not limited to this. The invention is also applicable to image forming apparatuses using different types of colors or numbers of colors, such as an image forming apparatus including only one image forming station for forming monochromatic images, and an image forming apparatus of rotary development system in which plural developers are mounted in a rotatable developing rotary. In more general terms, the invention may preferably be applied to all the image forming apparatuses having the constitution in which the toner image transferred to the recording material is fixed thereto by heating the toner image.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. An image forming apparatus, comprising:
an image forming section that forms a toner image and transfers the toner image to a recording material at a predetermined transfer position;
a fixing unit that heats the toner image on the recording material at a predetermined fixing position and fixes the toner image to the recording material;
a transporter that transports the recording material along a transportation path including a path extending from the transfer position to the fixing position;
a heat absorber that is located on the transportation path at a place downstream of the fixing position and absorbs a heat from the recording material;
a pre-heater that is located on the transportation path at a pre-heating position upstream of the transfer position and pre-heats the recording material passing through the pre-heating position; and
a heat transfer unit that transfers heat energy obtained by the heat absorber to the pre-heater.

2. An image forming apparatus according to claim 1, wherein the fixing unit includes a heating member that is heated to a predetermined fixing temperature and gives the heat to the recording material and the toner image thereon, and a heat generating member that heats the heating member to the fixing temperature.

3. An image forming apparatus according to claim 1, wherein
the heat transfer unit includes a ventilation path forming member that forms a ventilation path extending from a vicinity of the heat absorber to a vicinity of the pre-heater, and an airflow generator that generates an airflow flowing through the ventilation path from the heat absorber toward the pre-heater,
the heat absorber includes an air warming member that warms up an air in the ventilation path by using the heat energy obtained by heat absorption, and
the pre-heater includes a pre-heating member that is warmed up by the air flowing through the ventilation path and makes contact with the recording material at the pre-heating position.

4. An image forming apparatus according to claim 1, wherein
the heat transfer unit includes a heat pipe;
the heat absorber includes a heat absorbing member that is located at a place downstream of the fixing position, makes contact with the recording material to absorb the heat therefrom, and transfers the heat to one end of the heat pipe, and
the pre-heater includes a pre-heating member that is warmed up by drawing the heat from the other end of the heat pipe and makes contact with the recording material at the pre-heating position.

5. An image forming apparatus according to claim 1, wherein
the transporter includes a feeding member that is located on the transportation path at a feeding position upstream of the transfer position and feeds the recording material toward the transfer position, and
the pre-heating position is located on the transportation path at a place upstream of the feeding position.

6. An image forming apparatus according to claim 5, wherein
the transporter is structured to perform reverse transportation to transport the recording material having passed through the fixing position along a reverse transportation path and to return the recording material to the transportation path via a place upstream of the feeding position, and
the reverse transportation path is arranged to join the transportation path at a place between the feeding position and the pre-heating position.

7. An image forming apparatus, comprising:
an image forming section that forms a toner image and transfers the toner image to a recording material at a predetermined transfer position;
a fixing unit that heats the toner image on the recording material at a predetermined fixing position and fixes the toner image to the recording material;
a transporter that transports the recording material along a transportation path including a path extending from the transfer position to the fixing position;
a pre-heater that is located on the transportation path at a pre-heating position upstream of the transfer position and pre-heats the recording material passing through the pre-heating position; and
a heat transfer unit that transfers waste heat from the fixing unit to the pre-heater.

8. An image forming apparatus according to claim 7, wherein the fixing unit includes a heating member that is heated to a predetermined fixing temperature and gives the heat to the recording material and the toner image thereon, and a heat generating member that heats the heating member to the fixing temperature.

9. An image forming apparatus according to claim 7, wherein
the heat transfer unit includes an air feeder that feeds air, which is warmed up by the waste heat from the fixing unit, into the pre-heater, and
the pre-heater includes a pre-heating member that is warmed up by being exposed to the air fed by the air feeder and pre-heats the recording material by making contact with the recording material at the pre-heating position.

10. An image forming apparatus according to claim 7, wherein the pre-heating member has a hollow structure which allows the air, fed by the air feeder, to flow through inside the pre-heating member.

11. An image forming apparatus according to claim 7, wherein
the transporter includes a feeding member that is located on the transportation path at a feeding position upstream of the transfer position and feeds the recording material toward the transfer position, and
the pre-heating position is located on the transportation path at a place upstream of the feeding position.

12. An image forming apparatus according to claim 11, wherein
the transporter is structured to perform reverse transportation to transport the recording material having passed through the fixing position along a reverse transportation path and to return the recording material to the transportation path via a place upstream of the feeding position, and
the reverse transportation path is arranged to join the transportation path at a place between the feeding position and the pre-heating position.

13. An image forming method, comprising:
transporting a recording material along a predetermined transportation path and transferring a toner image to the recording material at a transfer position on the transportation path;
heating the toner image at a fixing position on the transportation path and downstream of the transfer position to fix the toner image onto the recording material;
absorbing the heat of the recording material at a place on the transportation path and downstream of the fixing position; and
pre-heating the recording material passing through a pre-heating position on the transportation path and upstream of the transfer position with a heat energy obtained by the heat absorption.

14. An image forming method, comprising:
transporting a recording material along a predetermined transportation path and transferring a toner image to the recording material at a transfer position on the transportation path;
heating the toner image with a fixing unit at a fixing position on the transportation path and downstream of the transfer position to fix the toner image onto the recording material;
transferring waste heat from the fixing unit to a pre-heating position on the transportation path and upstream of the transfer position; and
pre-heating the recording material passing through the pre-heating position with the heat thus transferred.
